(19) United States
(12) Patent Application Publication
(10) Pub. No.: US 2014/0122201 A1
(43) Pub. Date: May 1, 2014

(54) APPARATUS, METHOD, AND COMPUTER PROGRAM PRODUCT FOR ONLINE SOCIAL MARKETING

(71) Applicant: Aaron Johnson, Orem, UT (US)

(72) Inventor: Aaron Johnson, Orem, UT (US)

(21) Appl. No.: 14/067,724

(22) Filed: Oct. 30, 2013

Related U.S. Application Data
(60) Provisional application No. 61/720,288, filed on Oct. 30, 2012.

(51) Int. Cl. G06Q 30/02; G06Q 50/00

(52) U.S. Cl. CPC G06Q 30/0257; G06Q 50/01
USPC 705/14.19; 705/14.55; 705/14.45

(57) ABSTRACT

An apparatus, method, and computer program product are disclosed for online social marketing. A media module is configured to present multimedia content on a webpage featuring a user, the webpage comprising a theme selected by the user. An advertising module is configured to display advertising content on the webpage, the advertising content associated with the theme of the webpage. An icon module is configured to display one or more icons on the webpage, the one or more icons selected by the user, an icon representing one or more of a promotion and a cause associated with the user. A posting module is configured to post a link to the webpage on one or more social networking platforms associated with the user.

### CROSS-REFERENCES TO RELATED APPLICATIONS

This application claims the benefit of U.S. Provisional Patent Application No. 61/720,288 entitled “APPARATUS, SYSTEM, AND METHOD FOR ONLINE SOCIAL MARKETING” and filed on Oct. 30, 2012, for Aaron Johnson, which is incorporated herein by reference.

### FIELD

This invention relates to online advertising and more particularly relates to marketing via social media networks.

### BACKGROUND

Social media networks provide a platform for people to connect in an online, networked environment. In general, users may “follow,” “like,” etc., other users on the social media network. For example, a social media user may have over one million followers, which are other users of the same social media network as the user. It may be difficult, however, for a user to reach out to all their followers to promote goods and services. A celebrity, for example, may want to reach out to their fans to promote the goods they are endorsing. Thus, it may be beneficial to provide a more personalized and targeted social media marketing approach in order for users to utilize their social media fan base to promote goods and services.

### BRIEF SUMMARY

From the foregoing discussion, it should be apparent that a need exists for an apparatus, method, and computer program product for online social marketing. Beneficially, such an apparatus, method, and computer program product would deliver a more personalized experience while providing more effective targeted advertising.

The present disclosure has been developed in response to the present state of the art, and in particular, in response to the problems and needs in the art that have not yet been fully solved by currently available online social marketing methods. Accordingly, the present disclosure has been developed to provide an apparatus, method, and computer program product for synchronizing interactive content with multimedia that overcome many or all of the above-discussed shortcomings in the art.

In one embodiment, an apparatus is disclosed that includes a media module configured to present multimedia content on a webpage featuring a user. In some embodiments, the webpage includes a theme selected by the user. The apparatus, in another embodiment, includes an advertising module configured to display advertising content on the webpage. In one embodiment, the advertising content is associated with the theme of the webpage. In a further embodiment, the apparatus includes an icon module configured to display one or more icons selected by the user on the webpage. In certain embodiments, an icon represents one or more of a promotion and a cause associated with the user.

In another embodiment, the apparatus includes a posting module configured to post a link to the webpage on one or more social networking platforms associated with the user. In some embodiments, the cause represented by an icon includes a charitable cause selected by the user. In a further embodiment, an icon includes an action performed in response to user input. In some embodiments, the icon includes one or more attributes that define the action.

In a further embodiment, the apparatus includes an exchange module configured to exchange one or more icons associated with the user with one or more different icons associated with a different user. In some embodiments, the apparatus further includes a data tracking module configured to track behavioral data associated with one or more users of the webpage, wherein behavioral data includes demographic data and/or click data. In another embodiment, the apparatus includes a rewards module configured to provide rewards points to a user of the webpage in response to the user of the webpage performing one or more actions associated with the webpage. In certain embodiments, the rewards points may be exchanged for one or more of goods and services.

The apparatus, in one embodiment, includes an administration module configured to customize the content of the webpage. In some embodiments, a user customizes one or more of the media content, the advertising content, the icons, and the social networking platforms. In another embodiment, the apparatus includes an affiliate module configured to maintain a relationship between the user and one or more sponsors. In one embodiment, the user is a member of an affiliate program, wherein the user receives monetary compensation in response to a sponsored item displayed on the website being interacted with by a user of the website. In yet another embodiment, the one or more icons include a gaming icon, which is an item associated with a gamification system that includes users of the webpage and/or sponsors.

In one embodiment, a method is included that includes presenting multimedia content on a webpage featuring a user. In some embodiments, the webpage includes a theme selected by the user. The method, in another embodiment, includes displaying advertising content on the webpage. In one embodiment, the advertising content is associated with the theme of the webpage. In a further embodiment, the method includes displaying one or more icons selected by the user on the webpage. In certain embodiments, an icon represents one or more of a promotion and a cause associated with the user.

In another embodiment, the method includes posting a link to the webpage on one or more social networking platforms associated with the user. In some embodiments, the cause represented by an icon includes a charitable cause selected by the user. In a further embodiment, an icon includes an action performed in response to user input. In some embodiments, the icon includes one or more attributes that define the action.

In a further embodiment, the method includes exchanging one or more icons associated with the user with one or more different icons associated with a different user. In some embodiments, the method further includes tracking behavioral data associated with one or more users of the webpage, wherein behavioral data includes demographic data and/or click data. In another embodiment, the method includes providing rewards points to a user of the webpage in response to the user of the webpage performing one or more actions associated with the webpage. In certain embodiments, the rewards points may be exchanged for one or more of goods and services.

The method, in one embodiment, includes customizing the content of the webpage. In some embodiments, a user customizes one or more of the media content, the advertising content, the icons, and the social networking platforms. In certain embodiments, the method includes saving a webpage customization as a template, wherein a new webpage is created based on the previously used template. In another embodiment, the method includes maintaining a relationship between the user and one or more sponsors. In one embodiment, the user is a member of an affiliate program, wherein the user receives monetary compensation in response to a sponsored item displayed on the website being interacted with by a user of the website. In yet another embodiment, the one or more icons include a gaming icon, which is an item associated with a gamification system that includes users of the webpage and/or sponsors.

A program product is disclosed including a computer readable storage medium storing machine readable code executable by a processor to perform the operations. In one embodiment, the operations include presenting multimedia content on a webpage featuring a user. In some embodiments, the webpage includes a theme selected by the user. The operations, in another embodiment, include displaying advertising content on the webpage. In one embodiment, the advertising content is associated with the theme of the webpage. In a further embodiment, the operations include displaying one or more icons selected by the user on the webpage. In certain embodiments, an icon represents one or more of a promotion and a cause associated with the user. In another embodiment, the operations include posting a link to the webpage on one or more social networking platforms associated with the user.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of an online social marketing system in accordance with the present invention;

FIG. 2 is a schematic block diagram illustrating one embodiment of an online social marketing apparatus in accordance with the present invention;

FIG. 3 is a schematic block diagram illustrating another embodiment of an online social marketing in accordance with the present invention;

FIG. 4 is a schematic flow chart diagram illustrating one embodiment of a method for an online social marketing apparatus in accordance with the present invention;

FIG. 5 depicts one embodiment of creating a webpage in accordance with the present invention;

FIG. 6 depicts one example of an action that may occur when a user clicks on an icon in accordance with the present invention;

FIG. 7 depicts one example of an icon stack in accordance with the present invention; and

FIG. 8 depicts an embodiment of online social marketing in accordance with the present invention.

### DETAILED DESCRIPTION

References throughout this specification to features, advantages, or similar language do not imply that all of the features and advantages may be realized in any single embodiment. Rather, language referring to the features and advantages is understood to mean that a specific feature, advantage, or characteristic is included in at least one embodiment. Thus, discussion of the features and advantages, and similar language, throughout this specification may, but do not necessarily, refer to the same embodiment.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages of the embodiments will become more fully apparent from the following description and appended claims, or may be learned by the practice of embodiments as set forth hereinafter. As will be appreciated by one skilled in the art, aspects of the present invention may be embodied as a system, method, and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having computer readable program code embodied thereon.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of computer readable program code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of computer readable program code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the computer readable program code may be stored and/or propagated on in one or more computer readable medium(s).

The computer readable medium may be a tangible computer readable storage medium storing the computer readable program code. The computer readable storage medium may be, for example, but not limited to, an electronic, magnetic, optical, electromagnetic, infrared, holographic, micromechanical, or semiconductor system, apparatus, or device, or any suitable combination of the foregoing.

More specific examples of the computer readable storage medium may include but are not limited to a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), an optical storage device, a magnetic storage device, a holographic storage medium, a micromechanical storage device, or any suitable combination of the foregoing. In the context of this document, a computer readable storage medium may be any tangible medium that can contain, and/or store computer readable program code for use by and/or in connection with an instruction execution system, apparatus, or device.

The computer readable medium may also be a computer readable signal medium. A computer readable signal medium may include a propagated data signal with computer readable program code embodied therein, for example, in baseband or as part of a carrier wave. Such a propagated signal may take any of a variety of forms, including, but not limited to, electrical, electro-magnetic, magnetic, optical, or any suitable combination thereof. A computer readable signal medium may be any computer readable medium that is not a computer readable storage medium and that can communicate, propagate, or transport computer readable program code for use by or in connection with an instruction execution system, apparatus, or device. Computer readable program code embodied on a computer readable signal medium may be transmitted using any appropriate medium, including but not limited to wireline, optical fiber, Radio Frequency (RF), or the like, or any suitable combination of the foregoing

In one embodiment, the computer readable medium may comprise a combination of one or more computer readable storage mediums and one or more computer readable signal mediums. For example, computer readable program code may be both propagated as an electro-magnetic signal through a fiber optic cable for execution by a processor and stored on RAM storage device for execution by the processor.

Computer readable program code for carrying out operations for aspects of the present invention may be written in any combination of one or more programming languages, including an object oriented programming language such as Java, Smalltalk, C++, PHP or the like and conventional procedural programming languages, such as the “C” programming language or similar programming languages. The computer readable program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and computer program products according to embodiments of the invention. It will be understood that each block of the schematic flowchart diagrams and/or schematic block diagrams, and combinations of blocks in the schematic flowchart diagrams and/or schematic block diagrams, can be implemented by computer readable program code. The computer readable program code may be provided to a processor of a general purpose computer, special purpose computer, sequencer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The computer readable program code may also be stored in a computer readable medium that can direct a computer, other programmable data processing apparatus, or other devices to function in a particular manner, such that the instructions stored in the computer readable medium produce an article of manufacture including instructions which implement the function/act specified in the schematic flowchart diagrams and/or schematic block diagrams block or blocks.

The computer readable program code may also be loaded onto a computer, other programmable data processing apparatus, or other devices to cause a series of operational steps to be performed on the computer, other programmable apparatus or other devices to produce a computer implemented process such that the program code which executed on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present invention. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and computer readable program code.

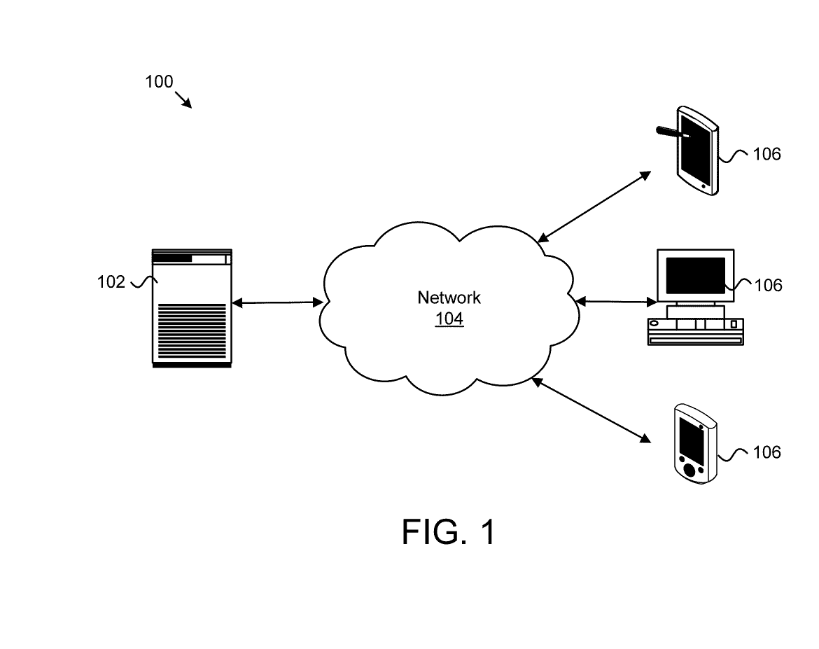

FIG. 1 is a schematic block diagram illustrating one embodiment of a system 100 for online social marketing. In the depicted embodiment, the system 100 includes a server 102, a network 104, and a plurality of electronic devices 106. Although for simplicity one server 102, one network 104, and three clients 106 are shown, any number of servers 102, networks 104, and clients 106 may be employed.

As used herein, the server 102 may be configured as a mainframe computer, a blade center comprising multiple blades, a desktop computer, a laptop computer, and the like. The server 102, in one embodiment, may include computer readable storage media storing executable code and may include a processor that executes the executable code as is well known to those skilled in the art. The executable code may be tangibly stored in computer readable storage media in communication with the server 102. The server 102 may store data regarding online social marketing, which may be accessed and/or downloaded over the network 104 by the plurality of clients 106.

In another embodiment, the system 100 includes a data network 104. The data network 104, in certain embodiments, is a digital communication network 104 that transmits digital communications related to online social marketing. The digital communication network 104 may include a wireless network, such as a wireless telephone network, a local wireless network, such as a Wi-Fi network, a Bluetooth® network, and the like. The digital communication network 104 may include a wide area network (“WAN”), a storage area network (“SAN”), a local area network (“LAN”), an optical fiber network, the internet, or other digital communication network known in the art. The digital communication network 104 may include two or more networks. The digital communication network 104 may include one or more servers, routers, switches, and/or other networking equipment. The digital communication network 104 may also include computer readable storage media, such as a hard disk drive, an optical drive, non-volatile memory, random access memory (“RAM”), or the like.

In one embodiment, the electronic devices 106 may be embodied as client devices. Each client 106 may be embodied as a portable computer, a handheld computing device, a touch device, a personal desktop assistant (“PDA”), a tablet computer, a mobile phone, a smart phone, and the like. A client 106 may include an operating system, for example Microsoft Windows®, Mac OS/X®, Linux, and/or the like. Mobile clients 106 may also include operating systems appropriate for their form factor, such as iOS®, Android®, Windows® Mobile, and/or the like. In some embodiments, each client 106 may communicate with the server 102 through the network 104. In another embodiment, a client 106 communicates with the server 102 by way of a program executing on the client 106, such as a mobile application configured to access, download, and/or upload data from the server 102. In certain embodiments, the application on the client device 106 may allow user interaction by using an input device, such as a keyboard, a stylus, and the like.

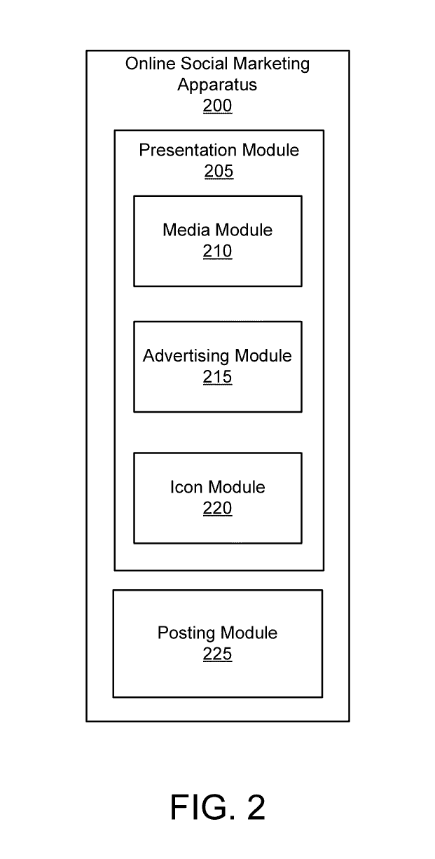

FIG. 2 is a schematic block diagram of one embodiment of an online social marketing apparatus 200 in accordance with the present subject matter. The online social marketing apparatus 200, in one embodiment, includes a presentation module 205, a media module 210, an advertising module 215, an icon module 220, and a posting module 225, which are described below.

The presentation module 205, in one embodiment, visually presents a personal software application on an electronic display of an electronic device 106. In some embodiments, the personal software application may be embodied as a personal webpage, a personal landing page, a personal blog, and/or the like. For example, a user may access the personal website using a web browser on a smart phone or tablet computer. In certain embodiments, the webpage includes media content provided by the media module 210, advertising content provided by the advertising module 215, and icons provided by the icon module 220. The webpage, in another embodiment, may be accessed through the network 104 by a network enabled client device 106.

In one embodiment, the media module 210 may be configured to present multimedia content on a webpage featuring a user. In another embodiment, the media module 210 embeds and displays media content within a personal media frame of the webpage. The media content, in some embodiments, may be stored on a remote server 102 and may be accessed through the network 104 by a client device 106 in order to be displayed in the webpage. For example, a smart phone may be in communication with a server 102 through a data network 104 in order to access media content provided by the media module 210. In another embodiment, the media content may include video, slideshows, music, or the like. The media content, in one embodiment, may be related to the theme of the webpage. For example, the webpage may be focused on a basketball theme. Thus, the media content displayed by the media module 210 may include a basketball related video or a slideshow of basketball related pictures. Further, in one embodiment, the media content may be played within a personal media frame, which may be designed to reflect the theme of the webpage.

The advertising module 215, in one embodiment, may be configured to display interactive advertising content on the webpage, which may also be related to the theme of the webpage. For example, continuing with the basketball example above, the advertising module 215 may display basketball related advertising, such as advertising for basketball products, basketball clothing, basketball event tickets, and the like. A user of the webpage, in one embodiment, may click on the advertisement to view more details regarding the goods and/or services being offered. In one embodiment, the advertising content may be stored on a remote server 102 and may be accessed by the advertising module 215 through the network 104 by a client device 106 in order to be displayed in the webpage.

In one embodiment, the icon module 220 is configured to display one or more icons on the webpage. In certain embodiments, the icons are selected by the user, e.g., the webpage creator. An icon, in one embodiment, may visually represent a business that is providing a promotion, such as a coupon, loyalty points, or the like, for clicking on their icon. In another embodiment, an icon may represent a cause, such as a charitable cause, a political campaign, or the like. In one embodiment, the webpage may reserve a portion of the display area for at least one icon representing a charitable cause. The icons, in some embodiments, are round and may portray a badge or seal. However, in other embodiments, icons may be embodied as any number of shapes and sizes. Further, the promotions and/or causes represented by the icons, in one embodiment, may be related to the theme of the webpage, as described above. In another embodiment, however, the icons may represent promotions and/or causes that are unrelated to the theme of the webpage and may reflect the interests of the webpage creator.

In one embodiment, the icon module 220 may perform an action when an icon is clicked on by a user. Each icon, in certain embodiments, may have different purposes and perform different actions when a user interacts with them. For example, an icon representing a product, when clicked, would take the user to a product description page or to an online shopping cart to purchase the product. In a further example, an icon representing a music track for a band may play the music track, take the user to the band's website, and/or take the user to an online music store to purchase the track. In one embodiment, the entity represented by an icon may incentivize a webpage creator to post the entity's icon on their webpage by providing payment in the form of currency, loyalty points, and the like, for each click the icon receives.

In a further embodiment, the icon module 220 may associate attributes with an icon that describe the behavior of the icon. In certain embodiments, the icon performs an icon in response to user input and the attributes define the action. Icon attributes, in one embodiment, may include the icon name, icon image, a URL link, at least one category the icon belongs to, and the like. In other embodiments, icons may be traded and/or exchanged with other webpage creators in an icon exchange system, as described below with reference to the exchange module 325.

In yet another embodiment, the icon module 220 displays icons that may be used as objects in a gamification system. In one example, icons may be used in “battles” between users of a collectible icon game, similar to traditional trading card games such as Pokémon®, Magic: The Gathering®, and the like. In one embodiment, players may use battle icons, which may contain attributes that define their “strengths” and “weaknesses” during a “battle,” in an attempt to defeat the opposing player and “knock out” the player's icons. In other embodiments, icons may express attributes that define different strategic behavior, such as offensive/defensive stealth, geo-location actions, triggers, traps, and the like. In some embodiments, a winning player may win icons or other prizes from the losing player. In a different example, the icon module 220 may display an icon as part of a larger treasure hunt organized by the entity represented by the icon, in which users may search for and collect icons as part of the treasure hunt. In another example, an icon may be a virtual “Easter egg,” such that it has unexpected behavior that is hidden from plain view, like a message, link, or the like, that may only be revealed by interacting with the icon.

The posting module 225, in one embodiment, may be configured to post a link to the webpage on a social networking platform associated with the user, such as Facebook®, Twitter®, Instagram®, and/or the like. In one embodiment, a user that clicks the link posted by the posting module 225 may be presented with the webpage by the presentation module 205. For example, a webpage creator may post on their Facebook page a link to their webpage instead of merely posting a video, a picture, or the like. In this manner, a more personalized experience is delivered while providing more effective targeted advertising to the creator's social media followers.

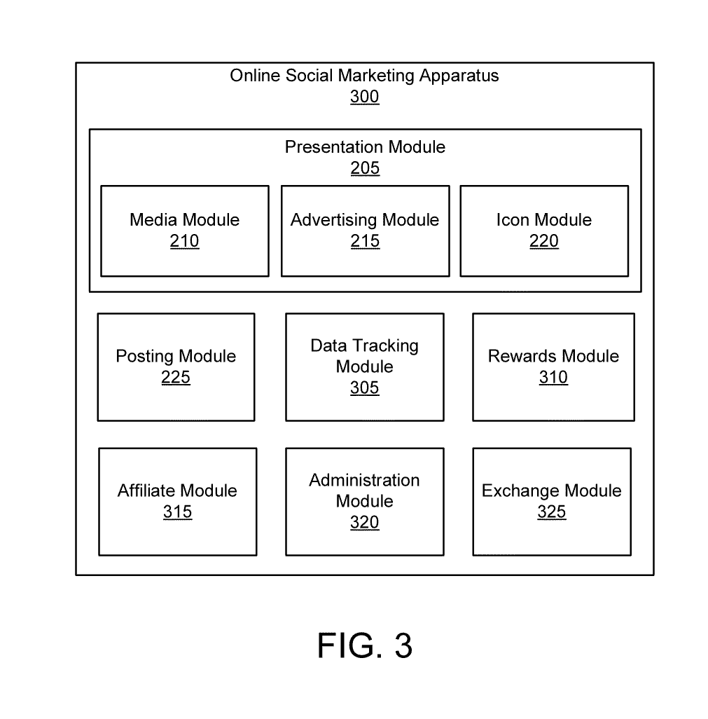

FIG. 3 depicts another embodiment of an online social marketing apparatus 300. The description of the apparatus 300 refers to elements of FIGS. 1 and 2, like numbers referring to like elements. The depicted apparatus 300 includes a presentation module 205, a media module 210, an advertising module 215, an icon module 220, and a posting module 225, wherein these modules may be substantially similar to the like numbered modules in FIG. 2. Further, the apparatus 300 includes a data tracking module 305, a rewards module 310, an affiliate module 315, an administration module 320, and an exchange module 325, which are described below.

The data tracking module 305, in one embodiment, may be configured to track and collect data from users of the webpage. The data collected by the data tracking module 305, in one embodiment, may include behavioral data, such as how long a user watched a video before it was stopped, when the user stopped the video, links that the user clicked, and the like. In another embodiment, the data collected by the data tracking module 305 may include demographic data of registered users, such as sex, age, and the like. The data tracking module 305, in some embodiments, stores the collected data in a computer readable storage medium, such as a database. In certain embodiments, the data tracking module 305 stores the data on a server 102, such as a cloud-hosted backup server, a local server, and/or the like.

In one embodiment, the rewards module 310 may be configured to provide rewards points to a user of the webpage in response to the user of the webpage performing one or more actions associated with the webpage. In certain embodiments, the rewards module 310 collects and stores a user's rewards points. The rewards module 310, in one embodiment, provides points earned by a user for performing certain actions, such as clicking on a link, clicking on an icon, sharing a page, or the like. In one embodiment, the rewards module 310 displays how many points a user receives for clicking on the icon. In some embodiments, the rewards points may be exchanged for goods or services from a variety of merchants, vendors, traders, and the like.

For example, a user may click on an icon representing Coca-Cola®, which may trigger a number of different actions, such as taking the user to the Coca-Cola® website, providing a pop-up with promotional advertising, and the like. By clicking on the icon, the user may earn a number of rewards points, which may be added to their rewards account. Subsequently, the user may be able to exchange their rewards points for Coca-Cola® products or other products or services from affiliate merchants. In another embodiment, the rewards points may be exchanged for entry into contests, giveaways, or the like. In other embodiments, the rewards points may be exchanged for real currency.

In one embodiment, the affiliate module 315 may be configured to maintain an affiliate program between affiliate members and sponsors. Webpage creators, in one embodiment, may register as an affiliate member and earn compensation from sponsors that have arranged to pay a specified amount to a webpage creator for displaying sponsored items in response to the sponsored items being clicked. In certain embodiments, the affiliate module 315 maintains a relationship between a webpage creator and the sponsors. For example, a sponsor's business or cause may be represented by an icon that has a monetary value associated with it such that when the icon is clicked by a user, the affiliate member will receive the monetary value as compensation. The monetary value, in another embodiment, may be visually displayed on an icon such that a webpage creator is aware of the per-click value of the icon.

The administration module 320, in one embodiment, may be configured to setup and manage the content of the webpage. In some embodiments, the administration module 320 is configured to customize the content of the webpage. In one embodiment, the administration module 320 customizes one or more of the media content, the advertising content, the icons, and/or the social networking platforms in response to user input. In certain embodiments, the administration module 320 provides a toolkit for a webpage creator to customize the content of the webpage. In one embodiment, the administration module 320 customizes the media frame, the media content, the advertising content, and the icons that are displayed in response to user input. In other embodiments, the administration module 320 may customize other display areas of the webpage. The administration module 320, in some embodiments, receives uploaded media content from a user, such as a webpage creator. The uploaded media content, in some embodiments includes media content, such as videos, photographs, music, and the like. In other embodiments, media content may be stored on a remote server 102, such as Facebook® or YouTube®, and may be accessed by the administration module 320 through a network 104. In another embodiment, the administration module 320 determines the social media platform where the posting module 225 posts the link to the webpage based on input received from the creator.

The administration module 320, in some embodiments, adds content to the display area by dragging and dropping the content from a list of available content in response to user input. Similarly, icons may be dragged and dropped onto the display area from a list of available icons. In one embodiment, the administration module 320 provides a preview of the webpage to a webpage creator before the webpage is made available to other users. In some embodiments, the administration module 320 saves a webpage creator's layout as a template, which a webpage creator could later use as a basis for a new webpage.

In one embodiment, the administration module 320 presents the list of available icons in a “sub-slide menu.” When an icon in the list of available icons is selected, for example, the “sub-slide menu” may replace the current list of available icons with another layer of available icons related to the selected icon. For example, selecting a general McDonald's® icon may bring in a “sub-slide menu” of icons representing various McDonald's® videos, different promotional incentives, or the like. Each icon in the “sub-slide menus” may also be dragged and dropped in the display area of the webpage. In one embodiment, each icon in the “sub-slide menu” may be selected to further reveal another level of icons in a new “sub-slide menu.”

The administration module 320, in other embodiments, allows a webpage creator to customize text displayed on the webpage. In one embodiment, a “call-to-action” item may be displayed, such that a user may share the webpage with others in their social network. The “call to action” item, in one embodiment, may be accompanied with customizable text encouraging users to share the webpage with others.

In certain embodiments, the exchange module 325 is configured to exchange one or more icons associated with the user with one or more different icons associated with a different user. In certain embodiments, a webpage creator may be a player in an icon collection and trading system such that a player may purchase a pack of icons, similar to a traditional trading card pack, which may be collected and/or traded with other participating players. For example, a player may characterize an icon as one that is available for trade. Other players that use the webpage may offer to trade one or more of their icons for the icon offered for trade. In one embodiment, the exchange module 325 displays a menu of trading options in response to a user clicking on the badge offered for trade.

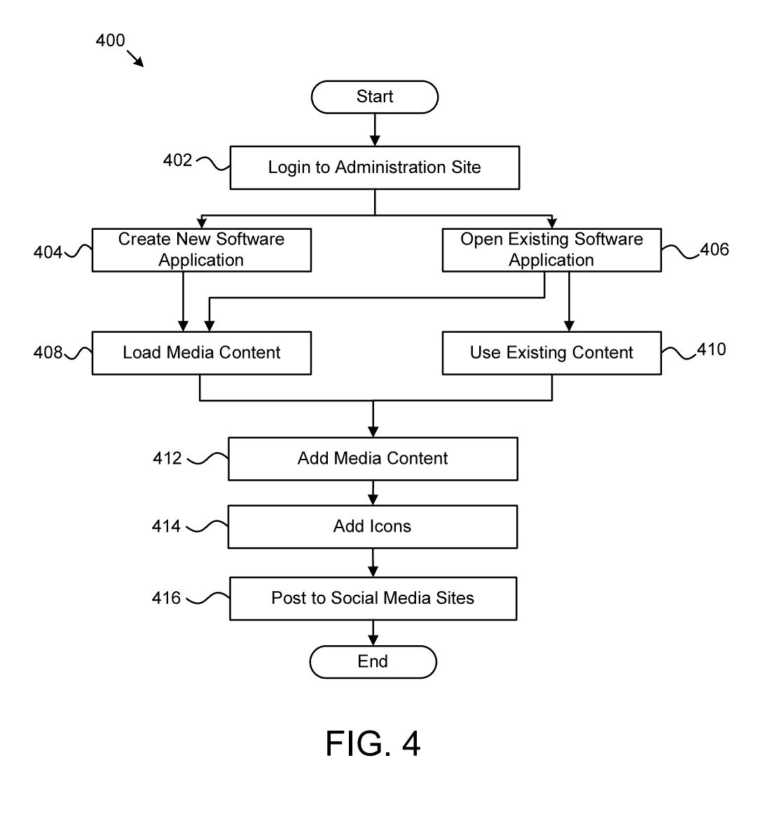

FIG. 4 is a schematic flow chart diagram illustrating one embodiment of a method 400 for creating a webpage. The method 400 begins and a webpage creator logs 402 in to the administration site. In one embodiment, the webpage creator creates 404 a new webpage from an existing template. In another embodiment, the webpage creator opens 406 an existing webpage for editing. Media content, in one embodiment, may be loaded 408 from a local server 102, or in some embodiments, from a remote server 102. The remote server 102, in one embodiment, may include social media sites such as Facebook®, YouTube®, and the like. In the case of editing an existing webpage, the webpage creator may load 408 new content or use 410 existing content that may have previously been uploaded.

In certain embodiments, the media module 210 may embed and display 412 media content in the webpage after it has been loaded. The media content, in certain embodiments, may comprise videos, photographs, and/or music, which may be added to the display area by dragging the content from a list of available content items and dropping the content in the display area of the webpage. Further, a list of available icons may be presented, which may be added 416 by the webpage creator through a drag and drop interface. The icons, in one embodiment, may include promotional icons or icons representing causes, such as charitable causes, political causes, and the like. In one embodiment, the icons may be presented by the icon module 220, which may display the available icons and place them around the personal media frame. The webpage creator may post 416 a link to their webpage on one or more social media sites. In one embodiment, the posting module 225 may post the link such that when the link is clicked, a user is presented with the webpage. In another embodiment, the webpage creator may manually copy and paste the link to the webpage in a social media site and the method 400 ends.

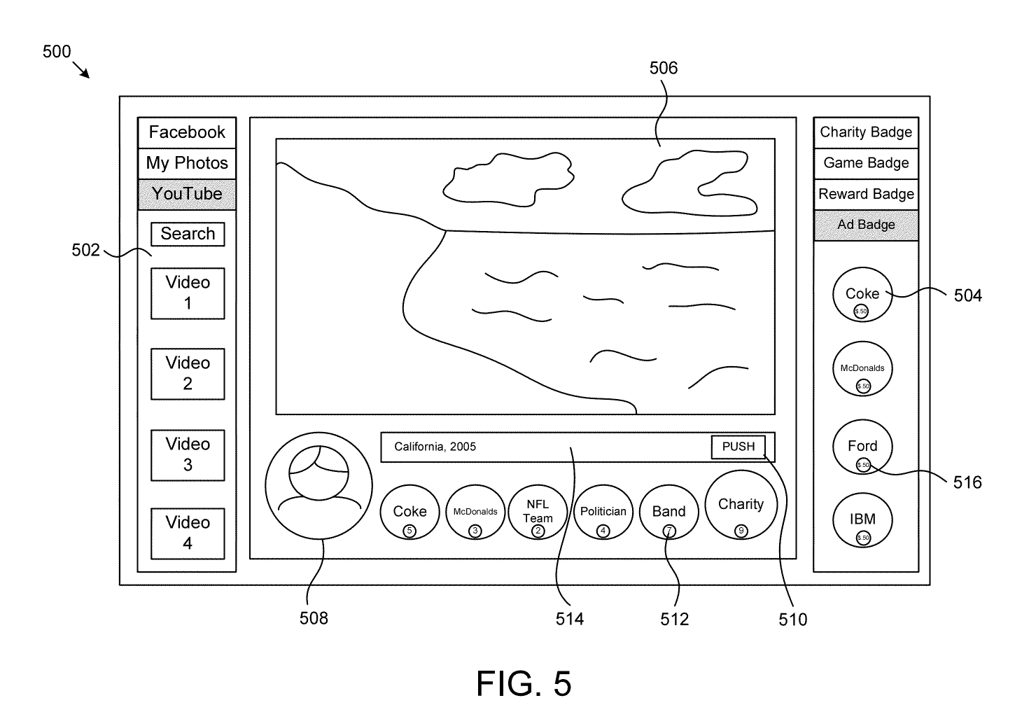

FIG. 5 depicts one embodiment of creating a webpage using the tools provided by the administration module 320. As shown, the media module 210 may present a list of available media content 502, such as videos, photographs, and/or music. In one embodiment, the media content 502 is loaded from a social media site such as Facebook®, YouTube®, and/or the like. In another embodiment, the media content 502 may be uploaded from a local server 102. Media content 502, in certain embodiments, may be dragged from the list and dropped into the main display area 506. In one embodiment, a slideshow may be created from multiple photographs selected from the available media content 502. In a further embodiment, transitions and effects provided by the media module 210 may be added to the slideshow. In other embodiments, music may be added to accompany the displaying of photographs during the slideshow.

In one embodiment, a list of available icons 504, or “badges,” may be presented by the icon module 220. A webpage creator may select one or more badges 504 from a list of available badges to be placed around the personal media frame surrounding the media display area 506. The badges, in one embodiment, may represent a promotion from a merchant, vendor, and the like. In a further embodiment, the badges may represent a cause, such as a charity, political campaign, and the like. The badges 504, in another embodiment, may display a number 512 representing the point value gained for clicking on the badge. When a user clicks on a badge 504, in one embodiment, the points collected from the click may be collected and stored in the user's account. In another embodiment, the monetary per-click value 516 of the badge may be displayed on the face of the badge. The monetary per-click value 516, in one embodiment, may be displayed when the webpage creator is an affiliate member, which may provide access to badges from sponsor entities.

Additionally, in some embodiments, an accent image 508 may be added by the webpage creator. In other embodiments, the accent image 508, similar to the media content 502, may be loaded from a remote and/or local server 102. Further, the embodiment as shown depicts a share, or “push,” button 510, which allows a user to share the webpage with others, for example, people in the user's social network. In one embodiment, the “push” button 510, when clicked, may display a pop-out screen where a user may select their social media sites to share a link to the webpage. In one embodiment, the posting module 225 posts a link to the webpage on the user's selected social media sites. A “call-to-action” phrase 514, in one embodiment, may be added by the webpage creator to encourage users to share the webpage with their followers.

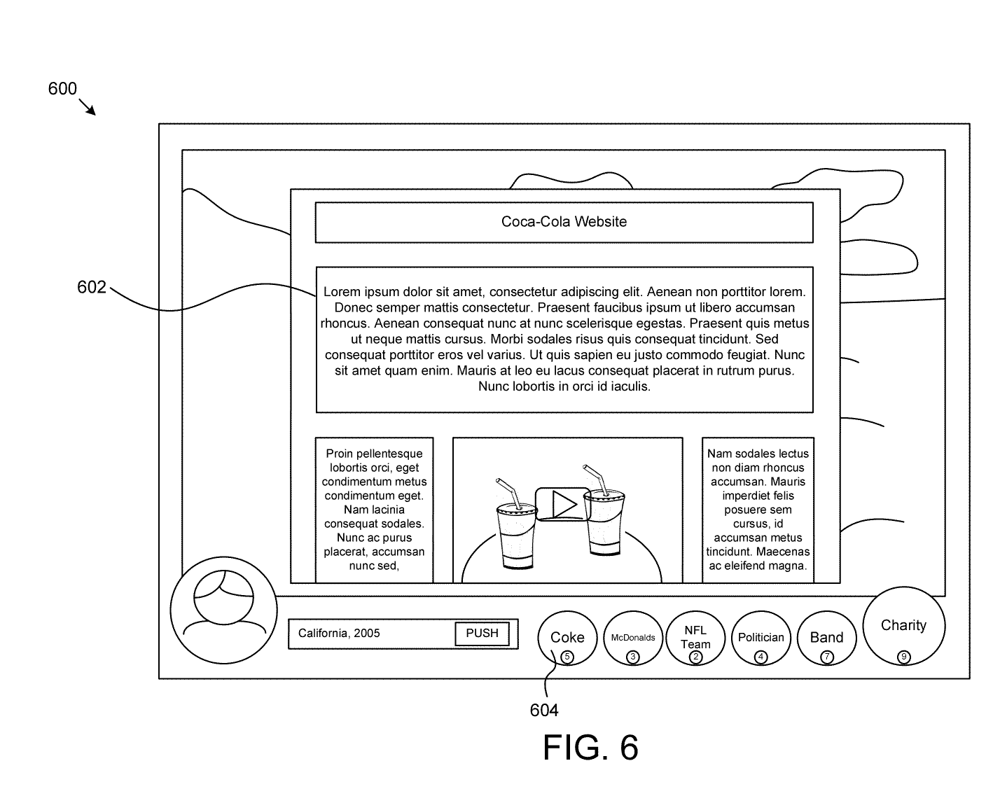

FIG. 6 depicts one example of an action that may occur when a user clicks on an icon 604, which, in one embodiment, may be presented by the icon module 220. In the depicted example, in response to a user clicking on an icon 604 representing the Coca-Cola® Company, Coca-Cola's® website 602 may be displayed in a pop-out window. In other embodiments, the pop-out window may contain interactive content, such as media content, advertising links, games, and the like. In another embodiment, the user may be taken directly to Coca-Cola's® website.

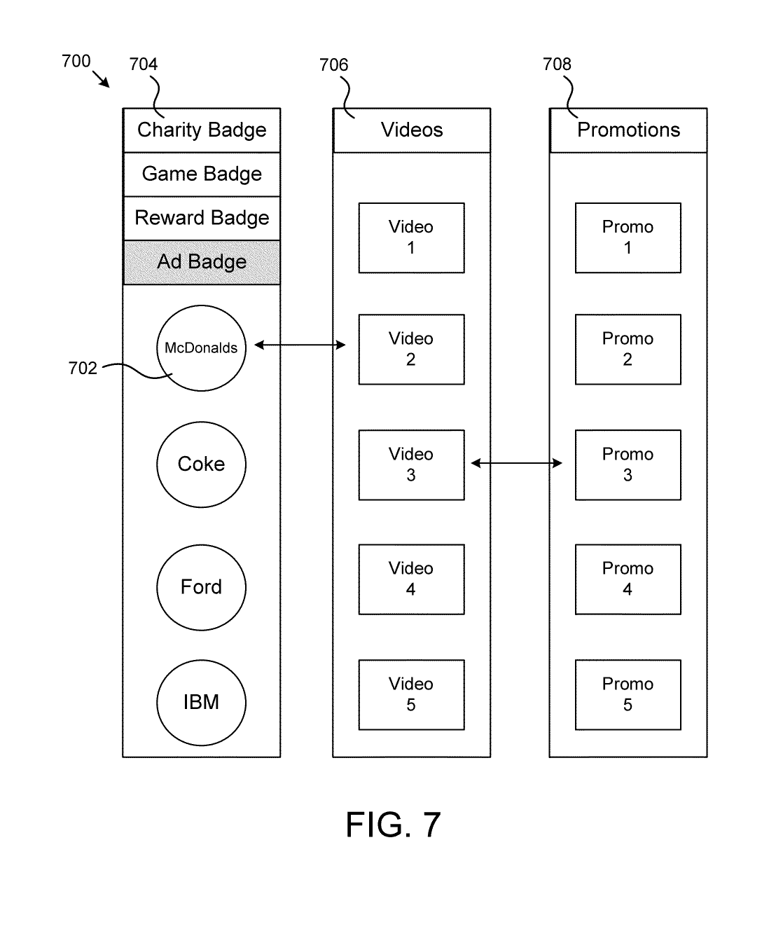

FIG. 7 depicts one example of a stack 704 of icons or badges. The badge stack 704 may include different types of badges, each with different attributes and actions associated with them. The badge stack 704 may include different levels 706, 708 of badges associated with a parent badge 702. For example, a webpage creator may click on a parent badge 702, such as a badge representing McDonald's®, which would expand the badge stack to present different types of McDonald's® related badges. The different types of badges may include video badges, promotional badges, advertising badges, and the like. In response to a user clicking on a video badge 706, for example, a badge stack 708 that includes promotional badges that accompany the selected video may be presented. Thus, in the depicted embodiment, after “Video 3” is selected, the promotional badges 708 associated with “Video 3” is presented.

In the depicted embodiment, the children badges 706, 708 are related to the parent badge 702 through the content and branding of the entity. Different parent badges 702, in other embodiments, may have different types of child badges, or may not have any child badges at all. Even though the depicted badge stack 704 is presented in a vertical stack, the badges in the stack could be presented in one or more horizontal rows. Moreover, on clients 106 with limited viewing areas, such as a smart phone, a horizontal or vertical badge stack may be scrollable such that not all available badges are viewable on the screen at the same time. A user, for example, may scroll through the badge stack using a finger to view all the available badges. For example, in the depicted embodiment, after the McDonald's® badge is selected, a user may scroll through different badge stacks associated with the McDonald's® badge, including a video stack, a promotion stack, and/or the like.

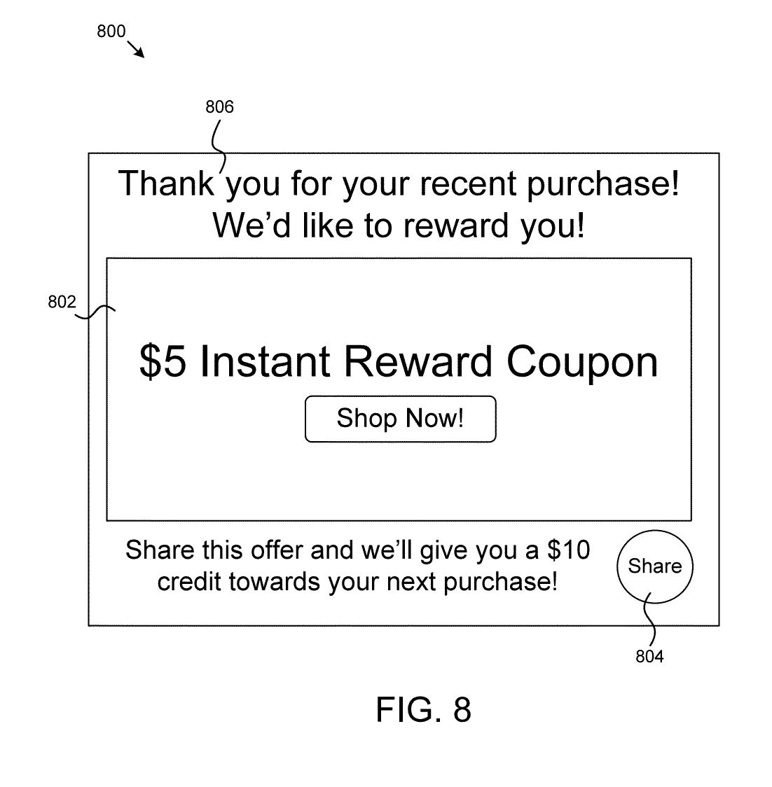

FIG. 8 depicts another embodiment of an online social marketing system. As shown, the presentation module 205 may present a webpage to a user based on a user's recent action, such as purchasing a product, reviewing an item, or the like. In one embodiment, the media content 802 may include promotional offers, contests, coupons, or the like to encourage the user to share the webpage. In one embodiment, the media content 802 may be presented to the user by the media module 210. A user, in another embodiment, may share the webpage by clicking a “share” button 804. In one embodiment, a user may select which of their social media sites to share a link to the webpage. In a further embodiment, the posting module 225 may post a link to the webpage on the selected social media sites. The text 806 of the webpage, in one embodiment, may be customized by the webpage creator. In another embodiment, icons may be displayed in the webpage by the icon module 220, as described above.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for personal social marketing, the method comprising:
presenting multimedia content on a webpage featuring a user, the webpage comprising a theme selected by the user;
displaying advertising content on the webpage, the advertising content associated with the theme of the webpage;
displaying one or more icons on the webpage, the one or more icons selected by the user, an icon representing one or more of a promotion and a cause associated with the user; and
posting a link to the webpage on one or more social networking platforms associated with the user.

2. The method of claim 1, wherein the cause represented by an icon comprises a charitable cause selected by the user.

3. The method of claim 1, wherein an icon comprises an action performed in response to user input, the icon comprising one or more attributes defining the action.

4. The method of claim 1, further comprising exchanging one or more icons associated with the user with one or more different icons associated with a different user.

5. The method of claim 1, further comprising tracking behavioral data associated with one or more users of the webpage, wherein behavioral data comprises one or more of demographic data and click data.

6. The method of claim 1, further comprising providing rewards points to a user of the webpage in response to the user of the webpage performing one or more actions associated with the webpage, wherein the rewards points may be exchanged for one or more of goods and services.

7. The method of claim 1, further comprising customizing the content of the webpage, wherein the user customizes one or more of the media content, the advertising content, the icons, and the social networking platforms.

8. The method of claim 7, further comprising saving a webpage customization as a template, wherein a new webpage is created based on the previously used template.

9. The method of claim 1, further comprising maintaining a relationship between the user and one or more sponsors, the user being a member of an affiliate program, wherein the user receives monetary compensation in response to a sponsored item displayed on the website being interacted with by a user of the website.

10. The method of claim 1, wherein the one or more icons comprises a gaming icon, wherein the gaming icon is an item associated with a gamification system comprising one or more of users of the webpage and sponsors.

11. An apparatus for online social marketing, the apparatus comprising:
a media module configured to present multimedia content on a webpage featuring a user, the webpage comprising a theme selected by the user;
an advertising module configured to display advertising content on the webpage, the advertising content associated with the theme of the webpage; and
an icon module configured to display one or more icons on the webpage, the one or more icons selected by the user, an icon representing one or more of a promotion and a cause associated with the user; and
a posting module configured to post a link to the webpage on one or more social networking platforms associated with the user.

12. The apparatus of claim 11, wherein the cause represented by an icon comprises a charitable cause selected by the user.

13. The apparatus of claim 11, wherein an icon comprises an action performed in response to user input, the icon comprising one or more attributes defining the action.

14. The apparatus of claim 11, further comprising an exchange module configured to exchange one or more icons associated with the user with one or more different icons associated with a different user.

15. The apparatus of claim 11, further comprising a data tracking module configured to track behavioral data associated with one or more users of the webpage, wherein behavioral data comprises one or more of demographic data and click data.

16. The apparatus of claim 11, further comprising a rewards module configured to provide rewards points to a user of the webpage in response to the user of the webpage performing one or more actions associated with the webpage, wherein the rewards points may be exchanged for one or more of goods and services.

17. The apparatus of claim 11, further comprising an administration module configured to customize the content of the webpage, wherein the user customizes one or more of the media content, the advertising content, the icons, and the social networking platforms.

18. The apparatus of claim 11, further comprising an affiliate module configured to maintain a relationship between the user and one or more sponsors, the user being a member of an affiliate program, wherein the user receives monetary compensation in response to a sponsored item displayed on the website being interacted with by a user of the website.

19. The apparatus of claim 11, wherein the one or more icons comprise a gaming icon, wherein the gaming icon is an item associated with a gamification system comprising one or more of users of the webpage and sponsors.

20. A program product comprising a computer readable storage medium storing machine readable code executable by a processor to perform:
presenting multimedia content on a webpage featuring a user, the webpage comprising a theme selected by the user;
displaying advertising content on the webpage, the advertising content associated with the theme of the webpage;
displaying one or more icons on the webpage, the one or more icons selected by the user, an icon representing one or more of a promotion and a cause associated with the user; and
posting a link to the webpage on one or more social networking platforms associated with the user.
